(19) United States
(12) Patent Application Publication
(10) Pub. No.: US 2004/0015318 A1
(43) Pub. Date: Jan. 22, 2004

(54) Automatic sensory logger

(76) Inventors: Alan C. Heller, (US); Andrew W. Stell, (US)

Correspondence Address: Freshloc Technologies Inc, Suite 100, 15443 Knoll Trail Drive, Dallas, TX, 75248, US

(21) Appl. No.: 10/618,386

(22) Filed: Jul. 11, 2003

Related U.S. Application Data
(60) Provisional application No. 60/395,383, filed on Jul. 11, 2002.

(51) Int. Cl. G06F 15/00

(52) U.S. Cl. 702/127

(57) ABSTRACT

A automatic sensory trip logger that provides wireless summary data about its trip log and creates an automatic and efficient mechanism for informing a receiver that a load of perishables may have been temperature abused. The invention includes a Logger, a Reader, a Gateway, a Server, a Processor, and a Notifier. The Logger includes a sensory element, data storage, a wireless transmitter and a battery. The transmitter uses a protocol which allows long battery life, in addition to automatic operation. The Reader is a wireless receiver tuned to the same frequency and protocol as the Logger's wireless transmitter. The Gateway collects sensory data from the Reader and forwards that data to the Server via the Internet. The Server accepts and stores data from the Gateway for retrieval and use by the Processor. The Processor formats data for graphing functions and determines whether a trip is “good” or “bad”, depending on parameters set by the user. The Notifier alerts the dispatcher or user at a trip's destination whether or not the cargo has been temperature abused (i.e. a “bad” trip).

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention relates generally to an automatic sensory logger and, more specifically, it relates to an automatic sensory logger for to provide a new automatic sensory logger that provides wireless summary data about its log and creates a highly automatic and efficient mechanism for informing a receiver that a load of perishables may have been temperature abused.

2. Description of the Prior Art

It can be appreciated that sensory loggers have been in use for years. Typically, sensory loggers are comprised of self contained devices called temperature data loggers. Although they often log temperature, they may log gasses, humidity, events such as switch closures, and other such things. For the purpose of temperature logging, these devices may be placed in and amongst the temperature sensitive contents in containers, food, cold storage sensitive contents in containers, food, cold storage spaces and such. Their data is available by way of contacting it or wirelessly addressing it and extracting the logged data.

The main problem with conventional sensory loggers is that the user must connect or be in close proximity to the sensory logger in order to extract data. Another problem with conventional automatic sensory loggers is that the devices require a person at the shipping (or sending) side to press a button on the logger device so that it may start logging. The manual aspects of these requirements make conventional sensory loggers prone to error (no pushed button—no log available), labor costs, labor training and the refurbishment/availability of a mobile device for every truck. Loggers that are fully automatic and wireless have high associated costs because they require two-way communication. Due to these inadequacies, most logs are not read for purposes of inspecting. The data is made available only days, weeks or even months after the return of the logger is made to the logger manufacturer. The receiver is then dependent upon the tenuous look, taste, smell or final temperatures which often are absent in known temperature abused shipments.

In these respects, the automatic sensory logger according to the present invention substantially departs from the conventional concepts and designs of the prior art, and in so doing provides an apparatus primarily developed for the purpose of providing a new automatic sensory logger that provides wireless summary data about its log and creates a highly automatic and efficient mechanism for informing a receiver that a load of perishables may have been temperature abused.

### SUMMARY OF THE INVENTION

In view of the foregoing disadvantages in the known types of automatic sensory trip loggers now present in the prior art, the present invention provides a new automatic sensory trip logger wherein the same can be utilized to provide wireless summary data about its trip log and create a highly automatic and efficient mechanism for informing a receiver that a load of perishables may have been temperature abused during transportation.

The present invention generally comprises a Logger, a Reader, a Gateway, a Server, a Processor, and a Notifier. The Logger includes a sensory element, data storage, a wireless transmitter and a battery. The Logger's wireless transmitter uses a unique protocol which provides a long life to the battery in addition to a continuous, automatic operation mode. The Reader is a wireless receiver tuned to the same frequency and protocol as the Logger's wireless transmitter. The Gateway collects sensory data from the Reader and forwards that data to the Server via a global computer Network, such as the Internet. The Server accepts and stores data from the Gateway for retrieval and use by the Processor. The Processor formats data for graphing/displaying functions and determines whether a trip is “good” or “bad”, depending on parameters set by a user. The Notifier alerts a dispatcher or the user at a trip's destination whether or not the cargo has been temperature abused (i.e. a “bad” trip).

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The present invention is to provide an automatic sensory trip logger that will overcome the shortcomings of the prior art devices.

One embodiment provides a new automatic sensory trip logger that provides wireless summary data about its trip log and creates an automatic and efficient mechanism for informing a receiver that a load of perishables may have been temperature abused.

In addition the automatic sensory trip logger allows the system, within a short period and with a minimum use of bandwidth, to automatically instruct the system and an assigned user the temperature integrity of the trip.

Also, the sensory trip logger is capable of providing stored data on the integrity of the trip to an Internet accessible database.

Furthermore, an automatic sensory trip logger instructs a user on the rare occasion that the trip integrity has been compromised to obtain a manual data log.

### BRIEF DESCRIPTION OF THE DRAWINGS

FIG. 1 is a block diagram of a trip logger, according to the present invention;

FIG. 2 is a block diagram of a system, according to the present invention;

FIG. 3 is the data format of the wireless data protocol;

FIG. 4 is a graph of a trip log;

FIG. 5 is a display of a trip log;

FIG. 6 is an entry screen for trip settings;

FIG. 7 is a graph of a trip log;

FIG. 8 is a flow chart of a method according to the present invention; and

FIG. 9 is a flow chart of a method according to the present invention.

### DETAILED DESCRIPTION OF THE INVENTION

Turning now descriptively to the drawings, in which similar reference characters denote similar elements throughout the several views, the attached figures illustrate an automatic sensory trip logger, which comprises a Logger, a Reader, a Gateway, a Server, a Processor, and a Notifier. The Logger includes a sensory element, data storage, a wireless transmitter and a battery. The transmitter uses a unique protocol which allows very long battery life in addition to automatic operation. The Reader is a wireless receiver tuned to the same frequency and protocol as the Logger's wireless transmitter. The Gateway collects sensory data from the Reader and forwards that data to the Server via a global computer network, such as the Internet. The Server accepts and stores data from the Gateway for retrieval and use by the Processor. The Processor formats data for graphing functions and determines whether a trip is “good” or “bad”, depending on parameters set by the user. The Notifier alerts the dispatcher or user at a trip's destination whether or not the cargo has been temperature abused (e.g., a “bad” trip).

The transmitter uses a protocol which allows long battery life in addition to automatic operation. The Logger stores relevant data for a specific period of time and transmits information about the data stored in its log on a continuous basis. In one embodiment, the logger measures and stores temperature data using an integrated temperature sensor. Other sensory information may be stored such as gases, humidity, voltage, current, or events such as shock or switch closures. In one embodiment, the logger stores temperature data for 16 hours, although longer or shorter periods may also be used. The logger summarizes each hour of its memory and transmits this summary data, two hours at a time, continuously. The data is sent wirelessly at a frequency and data protocol that are compatible with the Reader. The Logger may be adapted for use in monitoring gases, humidity, voltage, current, events such as switch closure, shock, vibration, global positioning system or other physical parameters.

Different versions of trip loggers may consider different actions for different sampling periods and downloading periods or unloading sequences. If an event causes changes to occur rapidly, the trip log may want to increase sampling rate. If changes occur less often, the sampling rate may decrease. With a change to firmware and a slight change to the message format, the logger could sample rapidly and download data slowly. For example, if the logger is sensing stable signals and finds a rapid change, it may chose to synchronize strictly on that event by sensing and logging (storing) that data at very short intervals. Since the event may be considered rare or occasional, the logger can download the higher speed event over longer intervals. If many sensors are synchronizing on the same event, the logging process will by itself alleviate the problem of collisions that would otherwise occur from many wireless sensors sampling at high rates and transmitting at high rates. One possible application might be for monitoring the high capacity batteries in a backup power system that were discharged. The discharge would be the triggering event and the voltage and temperature logs would be downloaded for each battery to see how they perform under load.

Multiple sensors can be designed into one logger with two serial numbers, one for each sensor. Voltage and temperature sensors can be combined into one logger to save money, space and also to allow a common decision to be made based on different combinations of sensory data between the two channels. Adding an additional sensor, such as a momentary button can also help to signal the logger to download (transmit) its data or a deep log of the data. This might occur for a complete replacement of in-transit trip loggers wherein a summary of the trip is always available and a full log is delivered upon a user command such as the push of a button.

The Reader is a wireless receiver tuned to the same frequency and protocol as the Logger's wireless transmitter. The Reader continually monitors its wireless receive channel and automatically detects the presence of a Logger. Receiver which is tuned to accept wireless signals from the Logger and format them into a serial RS485 data stream, and a PC to collect the serial data and send it to the Server via the Web. The reader is typically wired to the PC over a CAT5, RS-485 network but may be able to use network standards such as IEEE 802.11a or b, Proxim's proprietary network or other wireless networks. The Reader may be modified for different frequencies or updated for different data protocols as needed in order to stay compatible with updates to the Logger.

The Gateway collects sensory data from the Reader and forwards that data to the Server via the Internet. The Gateway collects all of the summary data from the Reader and sends that data to the Server via the Web. The Gateway is typically a PC running under Windows or Linux but may be a smaller embedded computer with decreased functionality.

The Server accepts and stores data from the Gateway for retrieval and use by the Processor. The server provides long term storage of logged data. It also provides recall of data to collaborating users for reviewing the status of a trip or group of trips. The Server may be a could be built around an Apache server running on Sun servers, Linux servers or the like. It could incorporate an Oracle database instead of a Microsoft database. The Server can be run from within an intranet without any exposure to the Wide-area Network.

The Processor formats data for graphing/displaying functions and determines whether a trip is “good” or “bad”, depending on parameters set by the user. The Processor is the analysis device to determine if there were deviances in that trip or group of trips. The Processor may be a software process operating on the same PC as the Server or it may be a separate PC or other computing device.

The Notifier alerts the dispatcher or the user at a trip's destination whether or not the cargo has been temperature abused (i.e. a “bad” trip). The Notifier receives data from the Processor and informs the collaborating user of any deviances or any other evidence of temperature abuse during the trip. It may inform the user via cellular phone or paging networks, or via email or some other medium. The Notifier may be a software process operating on the same PC as the Server or it may be a separate PC or other computing device.

The Logger may employ different frequencies, modulation techniques, or protocols. In addition, the Logger may be modified to have a larger or smaller Log Memory, as Needs require. The Processor and/or Notifier may be disabled and the Server only used to store sensory data as it is received from the Reader.

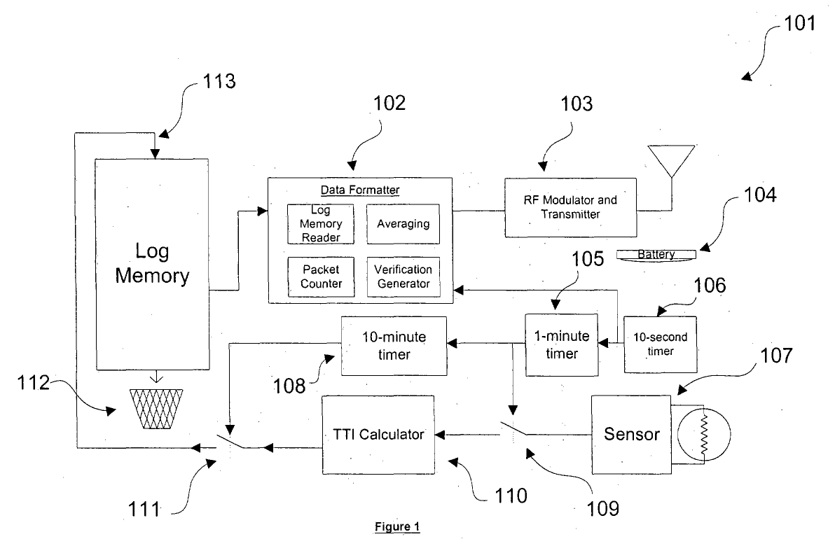

Turning now to FIG. 1, the Logger (101,) uses a temperature sensing element (107), such as a thermistor. Temperature is generally measured once per minute (105,109), and is processed by a TTI Calculator (110). The TTI Calculator (110) uses time-temperature integration, a form of averaging, which allows the sensor (107) to emulate a thermal time constant of 30 minutes. The Logger (101) includes a Log Memory (113), such as a First-In, First-Out (FIFO) dual-port memory. Data from the sensor (107) is generally sent to the Log Memory (113) by the TTI Calculator (110) every 10 minutes (108, 111). Each time new data is written into the Log Memory (113), the oldest data is erased (112). In the one embodiment, the Log Memory (113) holds 96 temperature data points, providing the Logger (101) 960 minutes or 16 hours of memory storage. Every 10 seconds (106), a Data Formatter (102) retrieves 12 data points from the Log Memory (113), or 2 hours of temperature data. The Data Formatter (102) combines each hour of data and places both hours into a single data packet (not shown in this figure but will be described in FIG. 3). The RF Modulator and Transmitter (103) then transmits a Verification Packet, Data Packet, and ID packets with escape codes in the 3rd byte of the Logger's ID (See FIG. 3, 303).

FIG. 3 shows the data protocol for the Logger (101) and a Reader (not shown). The 3rd byte escape codes (303) allow the Reader to be compatible with both the Logger and conventional, i.e. non-logging, sensors (302). At the conclusion of the RF Transmit cycle, the Data Formatter (102) increments the Packet Counter (102) causing it to transmit the next two hours of data on the next 10-second cycle. This cycle continues repeatedly until the Logger's battery (104) is depleted.

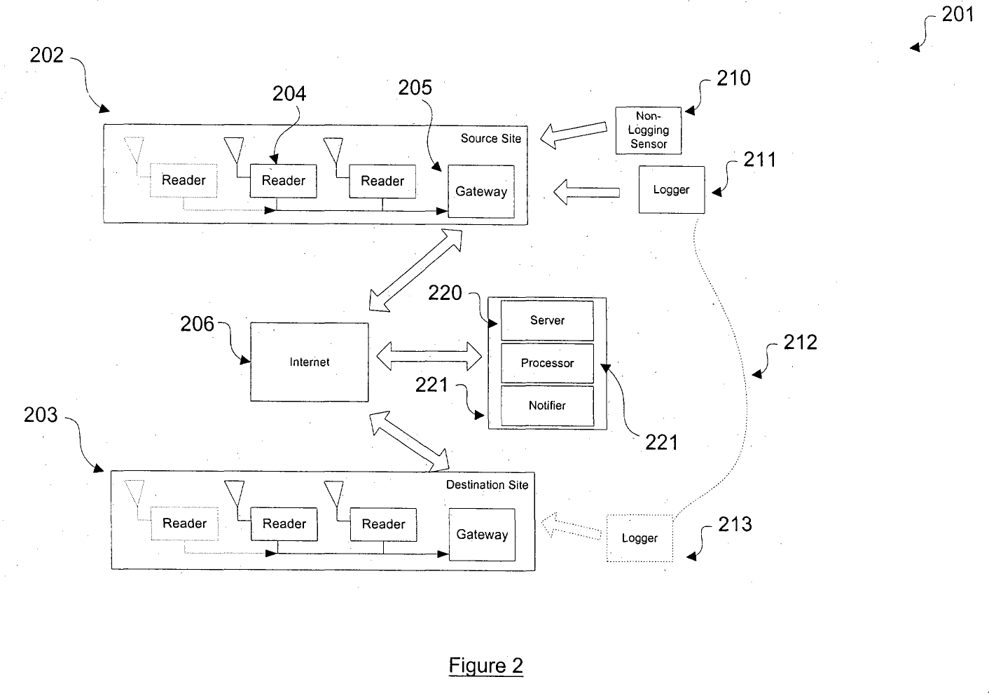

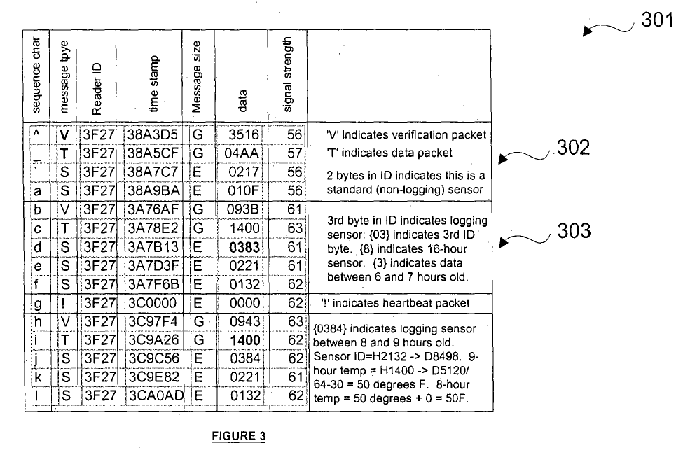

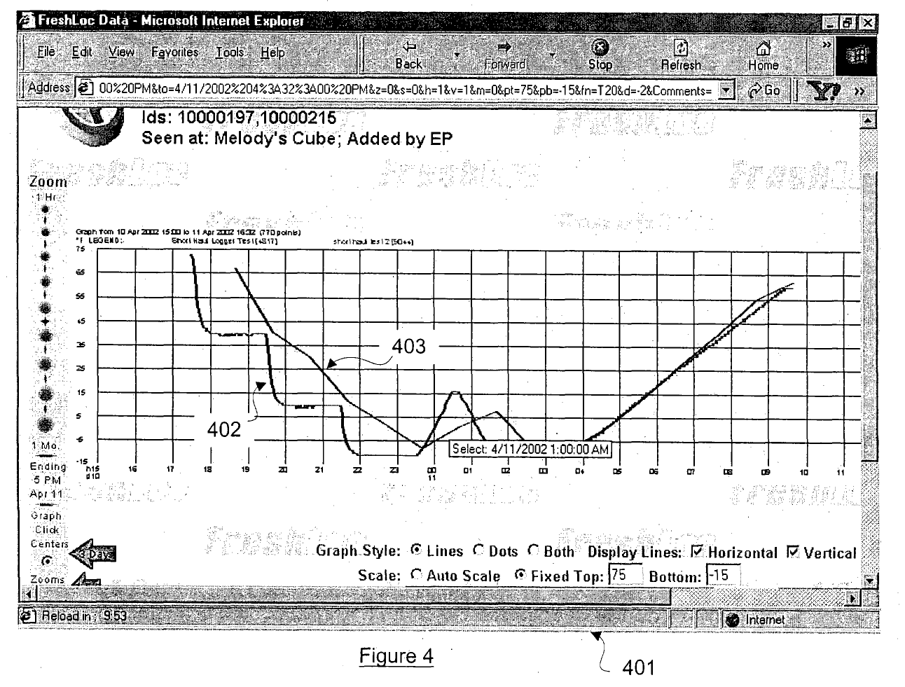

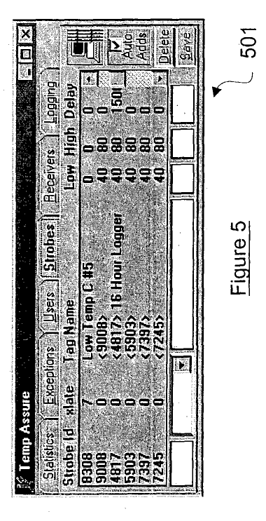

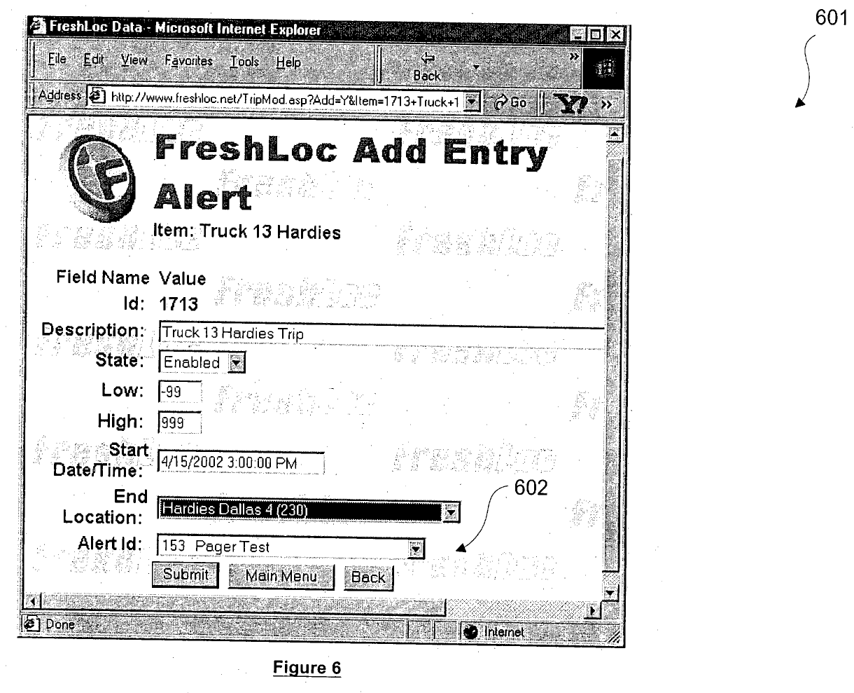

Turning now to FIG. 2, a System (201) includes Customer Source or Destination Sites (202, 203). The Customer Site (202, 203) includes at least one Reader (204) and an Internet Gateway (205). The Reader receives data packets from a Logger (211) and other compatible non-logging sensors (210) and converts them into a serial bitstream (not shown). The Gateway (205) collects the data packets from the Reader (204). Once all 16 hours of data has been received from an individual Logger (211), the Gateway sends the data to the Server (220) via the Internet (206). The Logger (211) continuously transmits a full 16 hours of data, including the time during a trip when the Logger (211) is not within the reception range of any Readers. The Reader/Gateway at the Destination site (203) detects automatically when a Logger (213) has reached its destination, without having to interrogate the Logger (213) or poll the system for the presence of Loggers. The Processor (221) is notified when a Logger (213) has reached the destination site (203) and determines whether the trip's sensory data falls within the limits set by a User (not shown). If the Processor (221) detects a problem, a Notifier (222) sends an alarm message to the User at the destination site (203). The method of notification may be an email, page, fax, telephone message or other method as desired by the user (not shown). Because the Server (220) provides long-term storage of the Logger's data, the data can be downloaded and viewed in a graphic or other display format. The Logger may be used in parallel with a detailed manually-loaded sensory logger (not shown) and compared to the summary data from the automatic Logger for detailed analysis in the event a problem is reported by the Logger.

As to a further discussion of the manner of usage and operation of the present invention, the same should be apparent from the above description. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A sensory logging system, comprising:
a sensor for monitoring parameters, the sensor providing the parameters in the form of a data stream;
a transmitter coupled to the sensor, said transmitter periodically sends present data and past data taken from the data stream to a receiver.
